(19) United States
(12) Patent Application Publication
(10) Pub. No.: US 2005/0192938 A1
(43) Pub. Date: Sep. 1, 2005

(54) System and method for displaying historical event information in association with geographic information

(75) Inventor: Tatsuhisa Miyanohara, Tokyo (JP)

Correspondence Address: ATTY;GREENBLUM & BERNSTEIN, P.L.C., 1950 Roland Clarke Place, Reston, VA, 20191, US

(73) Assignee: Encyclomedia Corporation, Tokyo (JP)

(21) Appl. No.: 10/788,285

(22) Filed: Mar. 1, 2004

(51) Int. Cl. G06F 17/30

(52) U.S. Cl. 707/3

(57) ABSTRACT

A system and a method for displaying historical event information in association with geographic information are provided that enable historical information in a database to be supplemented with map information so that a user can, by designating a desired place and date, chronologically overview the history of a region. The system includes supplementary information input means for utilizing a computer terminal to supplement computerized information on historical events with computerized map information on places where the historical events occurred, storage means enabling the computer to store historical event information associated with map information in a server, compilation means enabling the computer to select specific data designated from among historical event information stored by date and compile the selected data at display areas respectively designated by the supplementary map information, and output means for displaying the compiled information on a screen or the like by a designated method.

### BACKGROUND OF THE INVENTION

1. Field of the Invention

The present invention relates to a method for utilizing computerized historical event information, particularly to a system and a method for displaying historical event information in association with geographic information, which enable historical information in a database to be supplemented with map information so that a user can, by designating a desired place and date, chronologically overview the history of a region while simultaneously accessing historical information on other regions for the same period.

2. Description of Related Art

Japanese Unexamined Patent Publication No. 2000-99766 is typical of the state of the art prior to this invention.

Progress is being made in converting large-volume reference books, including dictionaries like Kojien, encyclopedias and the like, into electronic data for access using a computer, and systems capable of accessing and displaying such electronic data are already in existence. The countless number of historical events and huge amount of data concerning them has also stimulated advances in the computerization of such information. Various innovations have also emerged in the method of displaying electronic data. However, information on historical events is unique in the point of ordinarily being presented as divided into information relating to suitable regions, such as the East and the West. A striking example of this can be seen in the fact that Japanese history and world history are presented independently. Local history is treated similarly, with the history of individual towns and villages being compiled separately from that of surrounding regions.

Another aspect of this division can be seen in schools, where history taught at the middle school level and world history taught at the high school level are treated as separate subjects. When the foregoing method of division is adopted, the same historical event has to be presented through teaching materials for the respective educational courses that are matched to the progress and level of the educational process.

Owing to the division of historical events by region, a student of history is led to think that events that occurred in a particular region unfolded independently in that region. The student therefore usually has only a vague notion of, and cannot understand, how the events are related to those in other regions. This slows the student's acquisition of a broad understanding of history.

This tendency may be especially prevalent among Japanese because certain periods in Japan's history did in fact progress fairly independently of world history, so that students of Japanese history have felt no pressing need to keep the influence of world historical events constantly in mind. It is probably because of this that Japanese have developed a different way of viewing historical events from that of people in the countries of Europe and other areas where wars have regularly and dramatically reshaped national borders.

At any rate, the Japanese need to cultivate an awareness that Japanese history is one part of world history. Although possibly not as pronounced as in Japan, a similar situation can be assumed to exist in other countries around the globe.

To give a specific example regarding Japan, it is only after studying both Japanese history and world history and comparing the two that one realizes that the rule of the Japanese Queen and Priestess Himiko, mentioned in the Chinese story known as Gishi-wajinden, coincided with the time of the Three Kingdoms (Wei, Shu and Wu) in third-century China. An easier way to learn and assimilate such historical relationships will be indispensable from now on.

The emergence of data (information) that enables one to grasp the relationship between a given historical event and other historical events has long been desired. While attempts have been made to cross-reference Japanese and world history, the task is formidable and cross-references to world history have not always been made available. Even as recent history at that at the end of World War II has not been thoroughly grasped and is not being accurately taught as regards the military operations of Russia in the Far East and action on the European front.

Moreover, the fact that no particular historical events occurred in a region does not mean that the region has no history. But with regard to, for example, a region where history seems to have come to a standstill, it is hard to compile a history of either the region or individuals in the region.

An effort has been made to overcome the foregoing drawbacks by associating historical events with accurate map data. But in most cases the added information merely indicated the region, was not so precise and did not include detailed geographic information.

Up to now, such data has consisted mainly of a supplemental region or country name indicating where the event took place. But historical and current region and country names often do not match, so that the place where the event occurred was often not clear. Designations like the Persian Empire, the Ottoman (Turkish) Empire and the Byzantine Empire, for example, are confusing because the territories of these empires differed considerably depending on the date. While the designations may offer a general idea of where a historical event took place, they rarely pinpoint it. Actually, one may well be misled to think that all events tagged with these place names occurred in the capital of Constantinople.

The object of the present invention is therefore to overcome the foregoing problems by providing a system and a method for displaying historical event information in association with geographic information that enable historical information in a database to be supplemented with map information so that a user can, by designating a desired place and date, chronologically overview the history of a region while simultaneously accessing historical information on other regions for the same period.

### SUMMARY OF THE INVENTION

In order to achieve this object, the present invention provides a system for displaying historical event information in association with geographic information wherein a computer processing system for computer-editing electronic data on historical events and displaying the same on output means comprises: supplementary information input means for utilizing a computer terminal to supplement computerized information on historical events with computerized map information on places where the historical events occurred; storage means enabling the computer to store historical event information associated with map information in a server; compilation means enabling the computer to select specific data designated from among historical event information stored by date and compile the selected data at display areas respectively designated by the supplementary map information; and output means for displaying the compiled information on a screen or the like by a designated method.

The computerized map information is composed of Earth latitude and longitude data.

The present invention also provides and a method for displaying historical event information in association with geographic information comprising: a step of utilizing a computer terminal to supplement computerized information on historical events with computerized map information on places where the historical events occurred; a step wherein the computer stores historical event information associated with map information in a server; a step wherein the computer selects specific data designated from among historical event information stored by date and compiles the selected data at display areas respectively designated by the supplementary map information; and an output step of displaying the compiled information on a screen or the like by a designated method.

Moreover, a configuration is provided for displaying on a computer monitor screen a three-dimensional space wherein Earth latitude and longitude are respectively displayed along the vertical and horizontal axes of the computer monitor screen and dates are displayed along the depth axis of the computer monitor screen.

Since the system and method for displaying historical event information in association with geographic information according to the present invention are adapted to supplement computerized information on historical events with precise map information expressed as the latitude and longitude of the place where each event took place, they enable very exact compilation and display at a later time.

When the selected place is input to the computer, one or more historical events that occurred at the place or within a designated region including the place are selected and compiled from among the data stored in the computer, whereafter they are displayed on a screen or the like by a designated method. The screen display can be represented on a computer monitor screen as a virtual three-dimensional space wherein Earth latitude and longitude are respectively displayed along the vertical and horizontal axes of the computer monitor screen and dates are displayed along the depth axis of the computer monitor screen. This is particularly noteworthy because it provides very lucid visual information that enables the viewer to grasp clearly the order in which the related historical events unfolded and the distances between the places where they occurred.

### BRIEF DESCRIPTION OF THE DRAWINGS

FIG. 1 is a block diagram of a system for displaying historical event information in association with geographic information that is an embodiment of the present invention.

FIG. 2 is a front view of a monitor screen.

FIG. 3 is flowchart showing the sequence of procedures in an embodiment of the method for displaying historical event information in association with geographic information in accordance with the present invention.

### DESCRIPTION OF THE PREFERRED EMBODIMENTS

Embodiments of the present invention will now be explained in detail with reference to the drawings.

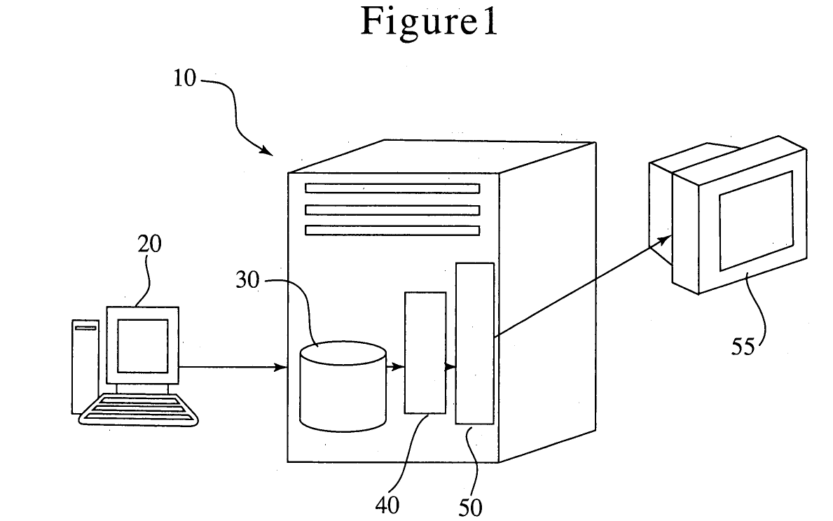

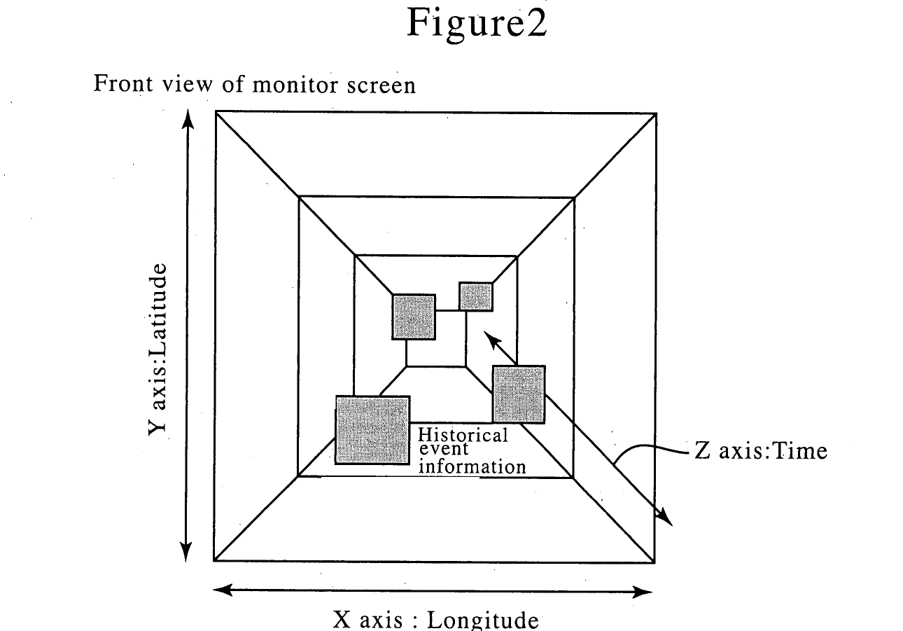

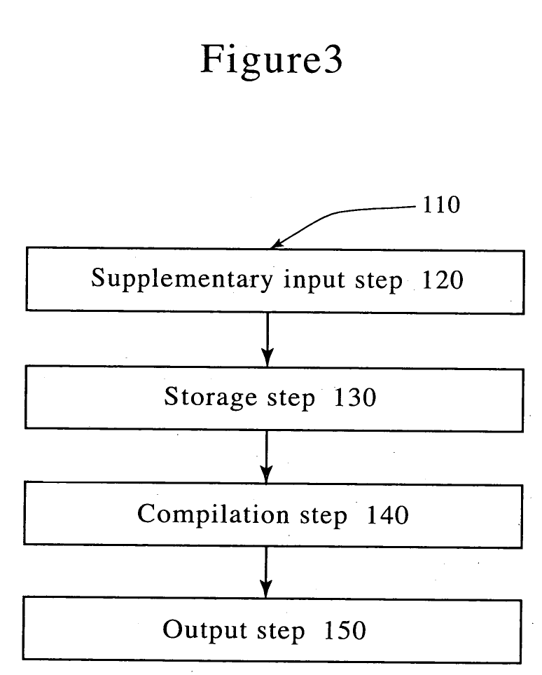

FIG. 1 is a block diagram of a system for displaying historical event information in association with geographic information that is an embodiment of the present invention, FIG. 2 is a front view of a monitor screen, and FIG. 3 is a flowchart of the method for displaying historical event information in association with geographic information in accordance with the present invention.

The system for displaying historical event information in association with geographic information of the illustrated embodiment, designated by reference numeral 10 in FIG. 1, includes a supplementary information input unit 20, a storage unit 30, a compilation unit 40, and an output unit 50. As shown in FIG. 2, the monitor screen 55 of the output unit 50 displays images three-dimensionally using an X (horizontal), Y (vertical) and Z (depth) orthogonal coordinate system.

All of the foregoing units are necessary when the user's computer and the server are not at the same location. When the user stores the data in his/her own computer, i.e., when the user has a standalone computer, the storage unit 30, compilation unit 40 and output unit 50 are incorporated in the local computer of the user.

The method for displaying historical event information in association with geographic information, designated by reference numeral 110 in FIG. 3, includes a supplementary input step 120, a storage step 130, a compilation step 140 and an output step 150. The supplementary input step 120, storage step 130 and compilation step 140 are executed in the local computer when the user's computer and the server are not at the same location.

The historical event information display system 10 constitutes a computer processing system for computer-editing electronic data on historical events and displaying the edited data on the display unit.

The supplementary information input unit 20 is for supplementing existing, processible electronic data on historical events with map information that is supplemented as electronic data from a computer terminal.

While the map information here is information composed of Earth latitude and longitude data, it is not limited to such information and can instead be other information such as country name, continent name, or name roughly designating a geographic region. The map information as termed with respect to the present invention can also consist of place names and the like supplemented with suitable latitude/longitude data. A country name used for the input can be either a current name like “Iran” or a name used in the past like “Persia.” Another possibility is to change the latitude and longitude assigned to a given country name in accordance with change in the location of its capital.

Latitude and longitude are used as the information for designating the region where historical events that are location-specific occurred because such information is by nature highly exact. When the latitude and longitude of an event are not certain, the name of a specific region in the vicinity is supplemented. In the case of Persia, for instance, the latitude and longitude of centrally located Isfahan can be designated as an approximate indication that is assigned to all related historical events whose exact point of occurrence is unknown.

A historical event that moves geographically can be assigned multiple sets of map information rather than the latitude and longitude of a single place.

The storage unit 30 enables the computer to store historical event information associated with geographic information in the computer, which data is stored in a storage device of the server as electronic data.

As explained earlier, when the user's computer and the server are not at the same location, a storage device installed in the user's computer is used as the storage unit 30. Similarly, the compilation unit 40 and output unit 50, which are explained below, are also units installed in the user's local computer in such a case.

The compilation unit 40 is for retrieving and compiling data designated by the computer. The computer operates in response to the instructions of the person making the retrieval (the user) to find and select designated (specific) information from among historical event information stored by date. Moreover, the compilation is conducted in a condition ready for output to display areas respectively designated by the map information assigned to the selected supplementary map information.

The output unit 50 is for displaying the selected information after compilation. The information is displayed on a CRT screen or liquid crystal display screen by a designated output method.

The monitor screen 55 can be one that produces a two-dimensional image but is preferably one that, as in this embodiment, displays images three-dimensionally using an X (horizontal), Y (vertical) and Z (depth) orthogonal coordinate system so that the historical events can be clearly understood visually.

The present invention allows the user to understand clearly, for example, what the situation was in Europe at the time of the Mongolian invasions of Japan in the thirteenth century, and also to ascertain the situation regarding Mongolia's conquest and rule of central Asia, as well as the strategy it adopted regarding Korea. Thus, a student of Japanese history can extend his/her understanding beyond the one-sided view of Japanese history, which deals with the invasions simply as battles between the Shoganate and Mongolia, to grasp their significance from a global perspective.

This feature also, for instance, enables a person studying Japan's Heian Period simply to check on the prevailing system of government and cultural advances in China at each point along the way.

The method 110 for displaying historical event information in association with geographic information consists of the supplementary input step 120, storage step 130, compilation step 140 and output step 150. The historical event information associated with geographic information is stored in the storage device of the computer, the computer responds to a user retrieve instruction by conducting retrieve and compilation processing, and responds to a user display instruction by outputting the retrieved and compiled data by a suitable output method.

The supplementary input step 120 is for supplementing computerized information on historical events with computerized map information regarding the locations where the events took place. The supplementary information is input through the computer terminal.

The storage step 130 is for enabling the computer to store the historical event information associated with geographic information in the computer. It stores electronic data in the server constituting the computer's storage device.

As explained earlier, when the user's computer and the server are not at the same location, the storage step 130 stores the electronic data in a storage device installed in the user's computer. The compilation step 140 and output step 150, which are explained below, are also implemented in the user's local computer in such a case.

The compilation step 140 is a step wherein the computer selects specific data designated from among historical event information stored by date and compiles the selected data at display areas respectively designated by the supplementary map information.

The output step 150 is for displaying the compiled information on a screen or the like by a designated method.

Although the output can be conducted in a planar fashion in the manner of a chronological table, it is also possible to adopt a three-dimensional screen configuration imparting a sense of virtual space.

In the preferred embodiments of the invention, therefore, the screen is configured to create a three-dimensional space effect with latitude represented horizontally, longitude represented vertically, and time (dates) represented depthwise of the computer monitor screen surface. In this configuration, the computer displays historical event information associated with geographic information in a virtual three-dimensional manner in accordance with the user's instructions.

Historical events that can be processed by the present invention of course include those of the distant past but are by no means limited to these. For example, this invention also markedly simplifies the work of associating modern and current historical events with map information.

It can, for instance, be applied to Japan's battles during World War II, the close of the war in Europe, the entry of the Soviet Union into the war against Japan and other related events to facilitate a broad understanding against the backdrop of the overall global scene.

It is also possible to provide still more detailed explanation of historical events through the use of still pictures and also to attach or add eye-catching information and analysis by the use of moving pictures.

With regard to modern history, the invention can further be applied microscopically to depict the histories of individual persons. By imputing modern history additionally with the histories of individuals starting from birth and extending through their adult years up to the present, it becomes possible to access their histories together with world history of the same period. Moreover, since the individual histories are input in association with latitude and longitude, it becomes possible to get a clear overall picture of an individual's movement from birth onward. Another possibility is to compile the historical events surrounding the individual's life in parallel with his/her personal history.

Being configured as set forth in the foregoing, the system and method for displaying historical event information in association with geographic information of this invention offer the following specific advantages:
1. The fact that historical event information associated with geographic information is made readily retrievable makes it possible to access teaching materials matched to the stage of education whenever needed. Since the computer automatically creates the electronic data for the historical information in accordance with the user's instructions, historical information for the required region and period can be conveniently obtained without omission, simply and at low cost. Moreover, the information can be obtained either in the form of a hard copy or as data displayed visually on a computer monitor. Whereas, the method used in conventional systems utilizing electronic data is to display historical events by date based on categorization by period or location. Some recent systems supplement historical events restricted to a designated region with referential historical events of other regions, this innovation intended to enable the user to realize that the events occurred about the same time.
2. The high precision of the map information expressed in latitude and longitude makes it possible to expand even fine distinctions by extracting them enlarged to the microscope level.

3. The method of displaying the historical event information associated with geographic information is simple, consisting of only input, storage, compilation and output steps, so that anyone can, by supplementing existing electronic data with map information, utilize existing historical information data as electronic data associated with map information.

4. Since the method used for display on a computer monitor screen enables a three-dimensional representation wherein Earth latitude and longitude are displayed along the vertical and horizontal axes and dates are displayed along the depth axis, the user can acquire a visual understanding and utilize teaching materials and the like which enable data involving visual aspects to be simply limited to the required range.

1. A system for displaying historical event information in association with geographic information wherein a computer processing system for computer-editing electronic data on historical events and displaying the same on output means comprises:
supplementary information input means for utilizing a computer terminal to supplement computerized information on historical events with computerized map information on places where the historical events occurred;
storage means enabling the computer to store historical event information associated with map information in a server;
compilation means enabling the computer to select specific data designated from among historical event information stored by date and compile the selected data at display areas respectively designated by the supplementary map information; and
output means for displaying the compiled information on a screen or the like by a designated method.

2. A system for displaying historical event information in association with geographic information according to claim 1, wherein the computerized map information is composed of Earth latitude and longitude data.

3. A method for displaying historical event information in association with geographic information comprising:
a step of utilizing a computer terminal to supplement computerized information on historical events with computerized map information on places where the historical events occurred;
a step wherein the computer stores historical event information associated with map information in a server;
a step wherein the computer selects specific data designated from among historical event information stored by date and compiles the selected data at display areas respectively designated by the supplementary map information; and
an output step of displaying the compiled information on a screen or the like by a designated method.

4. A method for displaying historical event information in association with geographic information characterized in displaying on a computer monitor screen a three-dimensional space wherein Earth latitude and longitude are respectively displayed along the vertical and horizontal axes of the computer monitor screen and dates are displayed along the depth axis of the computer monitor screen.
